(19) United States
(12) Patent Application Publication
(10) Pub. No.: US 2023/0097484 A1
(43) Pub. Date: Mar. 30, 2023

(54) Soft Baked Snack

(71) Applicant: General Mills, Inc., Minneapolis, MN (US)

(72) Inventors: Lauren Gillman, Saint Paul, MN (US); Eric Gugger, Plymouth, MN (US); Katie Wanner, Minneapolis, MN (US)

(73) Assignee: General Mills, Inc., Minneapolis, MN (US)

(21) Appl. No.: 17/908,986

(22) PCT Filed: Mar. 6, 2020
(86) PCT No.: PCT/US2020/021417

§ 371 Date: Sep. 2, 2022

(51) Int. Cl. A21D 13/062; A21D 2/18; A21D 2/26; A23L 33/125; A23L 33/17; A23L 33/21

(52) U.S. Cl. CPC A21D 13/062; A21D 2/26; A21D 2/181; A23L 33/17; A23L 33/21; A23L 33/125; A23V 2002/00

(57) ABSTRACT

A low net carbohydrate soft baked snack having a good texture, flavor, structure, and shelf stability is described. A soft baked snack includes a beneficial combination of fiber, sugar alcohol, including erythritol, and protein. Methods of making a soft baked snack are also described.

### BACKGROUND

Consumers are increasingly looking for foods that meet their nutritional needs without requiring preparation. Shelf stable baked snack items are a category of ready-to-eat foods that can be challenging to make fit both nutritional needs and a desired eating experience. Ready-to-eat baked products that contain relatively low sugar and net carbohydrate content provide a challenge for delivering a desirable taste and texture over the shelf life of the product. Thus, there is a need for good-tasting ready-to-eat products that meet desired nutritional needs and retain a desirable eating experience over shelf life.

### SUMMARY

The present disclosure relates to a low net carbohydrate food article that has a desirable texture and extended shelf life.

A soft baked snack is described, including a protein content of 3% to 20% by weight of the soft baked snack; a sugar alcohol content of about 15% to about 35% by weight of the soft baked snack, the sugar alcohol content including erythritol; a fiber content of at least 20% by weight of the soft baked snack; a sugar content of less than 15% by weight of the soft baked snack, wherein the sugar alcohol content, the fiber content, the sugar content, and a total carbohydrate content of the soft baked snack combine to achieve a net carbohydrate content of less than 25% by weight of the soft baked snack; a calorie content of 100 calories or less per 25 g of the soft baked snack; a moisture content of about 10% to about 18% by weight of the soft baked snack; and a water activity of less than 0.70. In some embodiments, protein content can be from 3% to 10% by weight of the soft baked snack. In some embodiments, net carbohydrate content can be from about 15% to less than 25% by weight of the soft baked snack. In some embodiments, sugar content can be from about 5% to about 10% by weight of the soft baked snack. In some embodiments, the moisture content can be from about 11% to about 15% by weight of the soft baked snack. In some embodiments, the water activity can be from about 0.55 to about 0.65.

In some embodiments, the soft baked snack can have a texture measured using a descriptive analysis panel (DAP) as having a first bite denseness, a first chew hardness, a first chew denseness, and a first chew cohesiveness that are greater than cake, and a first chew hardness that is less than a crunchy cookie.

In some embodiments, a soft baked snack can have a texture measured using instrumental texture profile analysis (TPA) as having a resilience, springiness, and cohesion that are significantly (>95% confidence) lower than cake, and a hardness that is significantly (>95% confidence) less than a crunchy cookie. In some embodiments, resilience can be less than 25%, the springiness is less than 80%, the cohesion is less than 0.6, and the hardness is less than 3000 g.

In some embodiments, sugar alcohol content can further include at least one additional sugar alcohol, with erythritol being 50% to 90% of the sugar alcohol content by weight. In some embodiments, the at least one additional sugar alcohol can comprise glycerol or sorbitol.

In some embodiments, the fiber can include inulin, soluble corn fiber, sugarcane fiber, or polydextrose.

In some embodiments, the calorie content can be 60 to 90 calories per 25 g of the soft baked snack.

In some embodiments, a soft baked snack can further include a fat content of less than 20%.

These and various other features and advantages will be apparent from a reading of the following detailed description.

### BRIEF DESCRIPTION OF DRAWINGS

FIG. 1 shows a model force over distance graph resulting from instrumental texture profile analysis to illustrate values used in measuring hardness and calculating resilience, springiness, and cohesion.

### DETAILED DESCRIPTION

Consumers often look for convenient foods that fit a desired nutritional profile. Low net carbohydrate content, low saturated fat content, low calorie content, and high protein content fit one such nutritional profile. Sugars can contribute to a desirable flavor and/or texture of shelf stable baked snacks, but they contribute to net carbohydrate content. As a result, reducing net carbohydrate content can negatively impact flavor and texture. In addition, increasing protein content in many convenient, shelf stable foods can result in textures or flavors that are off-putting, and can lead to hardening and/or drying over shelf life. Further, the drying effect of high protein content can lead to difficulty achieving a texture that resembles a brownie or a soft cookie rather than a crispy or hard cookie or a cake. While fats can be used, in part, to counteract the negative effects of reducing net carbohydrate content and increasing protein content on texture and taste, fats add unwanted calories. Thus, it is particularly challenging to produce a shelf stable soft baked snack with low calorie content, low net carbohydrate content, and high protein content with a brownie-like texture because ingredients that can be used to reach the desired nutritional content also push the texture of such a shelf stable baked snack toward a more cake-like or hard or crispy cookie-like texture.

It was discovered, and is disclosed herein, that a soft baked snack can be made having a low net carbohydrate content (e.g., less than 25%, from about 15% to less than 25%, or from about 15% to about 20% by weight of the soft baked snack) and a low calorie content (e.g., 100 calories or less, 90 calories or less, or from 60 calories to 90 calories per 25 g of the soft baked snack) that has a texture that is surprisingly more similar to a brownie or soft cookie rather than a crispy or hard cookie or cake and retains a soft baked snack texture over a packaged shelf life at room temperature of at least 60 days (e.g., at least 120 days, or at least 240 days). An inventive soft baked snack described herein achieves the above benefits by including a particular combination of protein, sugar alcohol, and fiber that allows for a combination of a desired nutritional profile, a unique texture, and a packaged shelf life where the soft baked snack texture is surprisingly stable.

A soft baked snack provided herein has a soft baked snack texture. As used herein, the term “soft baked snack texture” refers to a texture that more resembles a brownie or a soft cookie rather than a crispy or hard cookie or a cake. It is to be understood that a soft baked snack texture should be considered separately from any particulates included in a soft baked snack. For example, a soft baked snack provided herein can have a brownie like texture and include particulates that have a different texture. Particulates can include, for example, chocolate pieces, nuts, confectionary pieces, fruit pieces, and the like. Similarly, a soft baked snack texture should be considered separately from any toppings or coatings (e.g., confectionary drizzle, icing, or the like).

In some embodiments, soft baked snack texture can be measured using a trained descriptive analysis panel (DAP). When measured using a DAP, soft baked snack texture can be described as having a first bite denseness, a first chew hardness, a first chew denseness, and a first chew cohesiveness that are greater than cake, and a first chew hardness that is less than a crunchy cookie. When measured using a DAP, soft cookie texture and brownie texture also have a first bite denseness, a first chew hardness, a first chew denseness, and a first chew cohesiveness that are greater than cake, and a first chew hardness that is less than a crunchy cookie.

As used herein, first bite denseness is determined by a panelist by placing a sample in an upright orientation between the incisors and biting down evenly through the sample. First bite denseness is described by the panelist on a scale of 1 to 15, with 1 being most airy/fluffy and 15 being most dense/solid.

As used herein, first chew hardness is determined by a panelist by placing a sample in an upright orientation between the molars and biting down evenly through the sample. First chew hardness is described by the panelist on a scale of 1 to 15, with 1 being most soft and 15 being most hard.

As used herein, first chew denseness is determined by a panelist by placing a sample in an upright orientation between the molars and biting down evenly through the sample. First chew denseness is described by the panelist on a scale of 1 to 15, with 1 being most airy/fluffy and 15 being most dense/solid.

As used herein, first chew cohesiveness is determined by a panelist by placing a sample in an upright orientation between the molars and biting down evenly through the sample. First chew cohesiveness is described by the panelist on a scale of 1 to 15, with 1 described as having a texture that oozes when bitten and 15 described as having a texture that cracks or crumbles when bitten.

As described, below, soft baked snack texture can alternatively be measured using instrumental texture profile analysis (TPA). When measured using TPA, soft baked snack texture provided herein can be described as having a resilience (less than 25%, or less than 15%), springiness (less than 80%, or less than 70%), and cohesion (less than 0.6, or less than 0.4) that are significantly (>95% confidence) lower than cake (resilience greater than 25%, springiness greater than 80%, cohesion greater than 0.6), and a hardness (less than 3000 g, or less than 2000 g) that is significantly (>95% confidence) less than a crunchy cookie (greater than 3000 g). When measured using TPA, soft cookie texture and brownie texture also have a resilience (less than 25%), springiness (less than 80%), and cohesion (less than 0.6) that are significantly (>95% confidence) lower than cake (resilience greater than 25%, springiness greater than 80%, cohesion greater than 0.6), and a hardness (less than 3000 g) that is significantly (>95% confidence) less than a crunchy cookie (greater than 3000 g).

As used herein, TPA is measured using a TA-HDPlus texture analyzer (Stable Micro System, Godalming, United Kingdom). Samples were placed on the platform of the instrument in an upright orientation (with the top oriented upward), and a ½ inch jellybloom probe is used to compress the surface of each sample, near the center (i.e., away from edges) taking care to avoid surface cracks on the samples. The samples are subjected to two compressions at a rate of 1 mm per second to a probe strain of 20% with a 30 second interval between compressions.

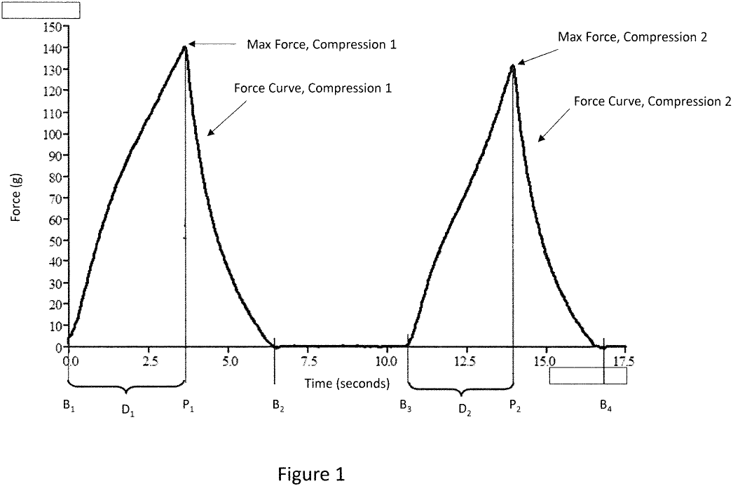

TPA resilience measurement generally describes how hard a sample pushes back on the TPA instrument’s probe to regain its original shape. As used herein, TPA resilience measurement refers to the ratio (measured as a percentage) of the area under the force curve from the peak of the first compression to the baseline divided by the area under the force curve from the baseline before the peak of the first compression to the peak of the first compression. Referring to FIG. 1, resilience (R) can be calculated using the equation:

$$\text{R} = {\text{A}}_{4} / {\text{A}}_{3}$$

where A₄ is the area under Force Curve, Compression 1 from P₁ to B₂ in FIG. 1, and A₃ is the area under Force Curve, Compression 1 from B₁ to P₁ in FIG. 1.

TPA springiness measurement generally describes how close to the original height a sample returns to after being compressed. As used herein, TPA springiness measurement refers to the ratio (measured as a percentage) of the distance the probe travels to reach peak force during the second compression divided by the distance the probe travels to reach peak force during the first compression. Referring to FIG. 1, springiness (S) can be calculated using the equation:

$$\text{S} = {\text{D}}_{2} / {\text{D}}_{1}$$

TPA cohesion measurement generally describes how well the structure of a sample recovers between the first and second compressions. As used herein, TPA cohesion measurement refers to the ratio (measured as a percentage) of the area under the force curve from the second compression divided by the area under the force curve from the first compression. Referring to FIG. 1, cohesiveness (C) can be calculated using the equation:

$$\text{C} = {\text{A}}_{2} / {\text{A}}_{1}$$

where A₁ the area under Force Curve, Compression 1 from B₁ to B₂ in FIG. 1, and A₂ is the area under Force Curve, Compression 2 from B₃ to B₄ in FIG. 1.

TPA hardness measurement generally describes how firm a sample is on the first compression. As used herein, TPA hardness measurement refers to the peak force measurement (in grams) from the first compression. Referring to FIG. 1, hardness is identified as Max Force, Compression 1.

As used herein, cake texture in a DAP and TPA is measured based on cake made from commercially available Betty Crocker Chocolate Supermoist cake mix made according to the manufacturer’s instructions. Measurements are taken on samples within 2 hours of cooling to room temp after removal from an oven.

As used herein, hard cookie texture in a DAP and TPA is measured based on commercially available, packaged Pepperidge Farm Bordeaux cookies within 2 hours of opening the package.

As used herein, brownie texture in a DAP and TPA is measured based on brownies made from commercially available Betty Crocker Fudge brownie mix made according to the manufacturer’s instructions. Measurements are taken on samples within 2 hours of cooling to room temp after removal from an oven.

As used herein, soft cookie texture in a DAP and TPA is measured based on commercially available, packaged (2 per pack) Grandma’s Peanut Butter soft cookies within 2 hours of opening the package.

A soft baked snack provided herein preferably has the desired low net carbohydrate content and low calorie content, including particulate, topping, and coating nutritional values, even if any particulates, toppings, or coatings have a relatively high fat and/or carbohydrate content. In particular, a soft baked snack provided herein has an advantage being able to include particulates, toppings, and/or coatings with relatively high fat and/or carbohydrate content while still providing a soft baked snack texture over an extended shelf life (e.g., at least 60 days, at least 120 days, or at least 240 days).

A soft baked snack provided herein has a low net carbohydrate content by weight of the soft baked snack. As used herein, net carbohydrate content in grams is calculated using the formula:

$${\text{CHO}}_{\text{net}} = {\text{CHO}}_{\text{total}} - \text{Fiber} - \text{Sugar Alcohol} - \text{Non-Nutritive Sugar}$$

where CHOₜₒₜₐₗ is total carbohydrate content in grams, Fiber is fiber content in grams, Sugar Alcohol is sugar alcohol content in grams, and Non-Nutritive Sugar is non-nutritive sugar (e.g., allulose) in grams. A low net carbohydrate content provides a nutritional profile desired for consumers who are avoiding or reducing their carbohydrate intake. A low net carbohydrate content in a packaged soft baked snack is often associated with a texture that is dry, crumbly, and/or hard. In addition, low net carbohydrate content in packaged soft baked snack is often associated with off-flavors from fiber and/or sugar alcohol. Also, low net carbohydrate content can reduce cohesive structure of a food, causing excessive crumbling. A soft baked snack provided herein achieves a low net carbohydrate content while retaining a desired flavor, texture, and structure.

Fiber content in a soft baked snack provided herein is at least 20% (e.g., at least 22%, from about 22% to about 30%, or about 23% to about 28%) by weight of the soft baked snack. In some embodiments, fiber content of a soft baked snack provided herein can be at least 20% without including contents of any particulate, topping, and/or coating included in the soft baked snack. Suitable fiber includes, for example, inulin, polydextrose, soluble corn fiber, sugarcane fiber (cellulose), or any combination thereof. In some embodiments, a fiber syrup, such as liquid inulin, liquid soluble corn fiber, and liquid polydextrose can be used. In some embodiments, a fiber syrup can contribute to a preferred texture of a soft baked snack provided herein. In some embodiments, amount, type, and combinations of fibers can be selected to adjust viscosity of a dough used to manufacture a soft bake snack provided herein. In some embodiments, amount, type, and combinations of fibers can be selected to adjust the rate of spread of a dough during baking to produce a soft bake snack provided herein.

In some embodiments, sugar alcohol content in a soft baked snack provided herein can be about 15% to about 35% (e.g., about 15% to about 30%, or about 18% to about 25%) by weight of the soft baked snack. In some embodiments, sugar alcohol content of a soft baked snack provided herein can be about 15% to about 35% without including contents of any particulate, topping, and/or coating included in the soft baked snack. Sugar alcohol content in a soft baked snack includes erythritol. In some embodiments, erythritol can comprise from about 50% to about 90% of the sugar alcohol content by weight. In some embodiments, at least one additional sugar alcohol can be included. Suitable additional sugar alcohols include, for example, glycerol, sorbitol, lactitol, and the like, or any combination thereof. In some embodiments, sugar alcohol content can include erythritol and one or both of sorbitol and glycerol.

In some embodiments, a non-nutritive sugar can be included in a soft baked snack provided herein. As used herein, “non-nutritive sugar” refers to a carbohydrate sweetener, such as allulose, that undergoes little to no metabolic transformation in the human body. In some embodiments, sugar alcohol plus non-nutritive sugar content in a soft baked snack provided herein can be about 15% or more (e.g., about 15% to about 35%, about 15% to about 30%, or about 18% to about 25%) by weight of the soft baked snack. In some embodiments, sugar alcohol plus non-nutritive sugar content of a soft baked snack provided herein can be about 15% or more without including contents of any particulate, topping, and/or coating included in the soft baked snack.

A soft baked snack includes a sugar content of less than 15% (e.g., less than 12%, less than 10%, or from about 5% to less than 10%) by weight of the soft baked snack. Sugars include any nutritive sweetener, such as sucrose, fructose, honey, brown sugar, molasses, and the like. In some embodiments, a soft baked snack can include substantially no sugar. In some embodiments, some or all of the sugar content of a soft baked snack can be included in a particulate, topping, and/or coating.

In some embodiments, one or more non-nutritive, high intensity sweetener can be included in a soft baked snack provided herein. Examples of suitable non-nutritive, high intensity sweeteners include, without limitation, stevia extract, sucralose, aspartame, and the like, or combinations thereof.

A soft baked snack provided herein includes a high protein content. As used herein, the term “high protein” content refers to a protein content of 3% to 20% (e.g., 3% to 15%, or 3% to 10%) by weight of the soft baked snack. Suitable protein ingredients typically contain at least 70% (e.g., at least 80%) by weight, such as protein concentrates or protein isolates. Examples of suitable protein ingredients include, without limitation, dairy protein ingredients (e.g., milk protein, whey, caseinate, nonfat dried milk, and the like), egg ingredients (e.g., whole egg, egg white, egg yolk, and the like), other animal-based protein ingredients (e.g., collagen, gelatin, and the like), legume protein ingredients (e.g., soybean, lentil, pea, and the like), grain protein ingredients (e.g., wheat, barley, oat, and the like), seed protein ingredients (e.g., sunflower seed, quinoa, and the like), microbe-derived protein ingredients (e.g., bacterial protein concentrates and/or isolates, fungal protein concentrates and/or isolates, algal protein concentrates and/or isolates, and the like), or any combination thereof.

In some embodiments, proteins with low functionality in the product matrix can be selected. For example, proteins that are low water binding, low or non-gel forming, low or non-soluble, or if soluble non-gel forming, can be selected. Examples of proteins with low functionality in the product matrix include, for example, calcium caseinate, soy protein isolates, soy protein concentrates, and collagen. In some embodiments, protein comprising calcium caseinate, a soy protein isolate, or a combination thereof can be used.

In some embodiments, protein content of other ingredients, such as a flour ingredient (e.g., wheat flour, oat flour, nut flour, and the like), can contribute to protein content, but typically does not contribute the entire protein content of a soft baked snack provided herein.

In some embodiments, a soft baked snack can have a fat content of less than 20% (e.g., less than 15%, or about 5% to about 10%) by weight of the of the soft baked snack. Any edible fat can be used, including oils, hard fats, and shortenings. In some embodiments, the fat content of a soft baked snack can contribute less than 20% (e.g., less than 15%, or less than 12%) by weight saturated fat. In some embodiments, a soft baked snack can contain substantially no saturated fat. In some embodiments, some or all of the fat content of a soft baked snack can be included in a particulate, topping, and/or coating. In some embodiments, some or all of the saturated fat content of a soft baked snack can be included in a particulate, topping, and/or coating.

In some embodiments, a flour can be included in a soft baked snack provided herein. For example, a soft baked snack can have a flour content of about 10% to about 20% (e.g., about 10 to about 15%, or about 12 to about 15%) by weight of the soft baked snack. In some embodiments, flour content of a soft baked snack provided herein can be about 10% to about 20% without including contents of any particulate, topping, and/or coating included in the soft baked snack. Any flour can be used, including one or more grain flour (e.g., wheat, oat, barley, and the like), one or more nut flour (e.g., peanut, almond, cashew, and the like), one or more root flour (e.g., tapioca, potato, and the like), and the like, or any combination thereof. In some embodiments, a combination of a grain flour (e.g., oat flour) and a nut flour (e.g., peanut flour) can contribute a good texture while providing additional protein.

In some embodiments, a soft baked snack provided herein can include particulates. In some embodiments, particulates can be included in an amount of up to 15% (e.g., about 2% to about 10%, or about 5% to about 10%) by weight of a soft baked snack provided herein. Suitable particulates include, for example, chocolate chips or pieces, flavored compound coating based pieces or chips (e.g., butterscotch, cinnamon, or fruit-flavored chips), nuts or nut pieces, dried fruit pieces, and the like. In some embodiments, the amount and type of particulate to be included in a soft baked snack can be selected to achieve or retain a preferred nutritional profile for the soft baked snack, such as net carbohydrate content or caloric content, as described above. A particulate can contain any suitable ingredient, such as sugar alcohol, protein, fiber, flavors, spices, fats, and the like.

In some embodiments, a soft baked snack provided herein can include a coating or a topping on at least one surface of the soft baked snack. In some embodiments, a coating or a topping can comprise up to 15% (e.g., about 2% to about 10%, or about 5% to about 10%) by weight of a soft baked snack provided herein. A coating or topping can be applied in any appropriate way, such as a layer or a drizzle on a surface of a soft baked snack. As with particulates, an amount or type of coating or topping to be applied to a surface of a soft baked snack can be selected to achieve or retain a preferred nutritional profile for the soft baked snack, such as net carbohydrate content or caloric content, as described above. An example of a suitable coating or topping can include a compound coating-based composition. A coating or topping can contain any suitable ingredient, such as sugar alcohol, protein, fiber, flavors, spices, fats, and the like.

In some embodiments, a coating or a topping can be included on only a portion of at least one surface of a soft baked snack. Such a coating or topping typically does not prevent moisture changes in a soft baked snack over shelf life. Surprisingly, even if a soft baked snack provided herein is not completely coated, it retains a preferred texture over shelf life.

Additional ingredients can be included in a soft baked snack provided herein. For example, emulsifiers (e.g., lecithin, or the like), flavorants (e.g., spices, extracts, cocoa powder, or the like), colorants (e.g., extracts, fruit and/or vegetable juices, dyes, and the like), salts (e.g., table salt, sea salt, and the like), and leaveners (e.g., sodium bicarbonate, sodium aluminum phosphate, and the like), or any combination thereof, can be included in a soft baked snack provided herein.

A soft baked snack provided herein can have a moisture content of from about 10% to about 18% (e.g., about 11% to about 15%) by weight. A moisture content of from about 10% to about 18% (e.g., about 11% to about 15%) can contribute to a desirable texture of a soft baked snack provided herein. A moisture content within this range can also contribute to an extended shelf life by reducing microbial activity within the article. In some embodiments, a soft baked snack provided herein can have an extended shelf life, despite being free of potassium sorbate, sodium proprionate, and fermentates that inhibit mold growth.

In some embodiments, a soft baked snack provided herein can have a water activity of less than 0.70 (e.g., from about 0.55 to less than 0.70, or from about 0.55 to about 0.65). A water activity of less than 0.70 (e.g., from about 0.55 to less than 0.70, from about 0.55 to about 0.65, or from about 0.60 to about 0.65) can contribute to an extended shelf life by reducing microbial activity within the article.

A soft baked snack provided herein can have any appropriate form. For example, a soft baked snack provided herein can resemble a snack bar or a cookie. A soft baked snack provided herein can be enjoyed by consumers alone, with other food compositions, such as spreads, toppings, or as a topping itself on other foods, such as ice cream, yogurt, or the like.

A soft baked snack provided herein can be packaged in any suitable packaging, such as a foil, plastic wrapper, metallized polypropylene, and the like. In some embodiments, a packaging material can inhibit oxygen and/or moisture transfer between the inside of a package and the outside of the package.

Also provided herein are methods of making a soft baked snack provided herein. A soft baked snack provided herein can be made from a dough having a moisture content of from about 15% to about 20% (e.g., from about 16% to about 18%) by weight of the dough, which is formed using, for example, a mixer or extruder, and then baked to a moisture content of about 11% to about 15% to form a soft baked snack described herein. A suitable dough typically contains sufficient protein ingredient, sugar alcohol, and fiber content to achieve a soft baked snack having the fiber, protein, and sugar alcohol content described above. It is to be understood that the contents of the dough can be adjusted accordingly to result in a soft baked snack as described above once formed and baked.

A dough can be made using any appropriate method and equipment. Particularly useful is a method where a dough is formed by first combining liquid ingredients and then adding dry ingredients using a scraped-surface mixer. Such a method produces a dough that can conveniently be formed using an extruder.

A method provided herein can optionally include combining the soft baked snack with one or more additional food compositions (e.g., a confectionary drizzle or coating).

The following examples are provided to show selected embodiments of the invention described herein. The examples are not intended to limit the invention to any particular embodiment.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A soft baked snack, comprising:
a. a protein content of 3% to 20% by weight of the soft baked snack;
b. a sugar alcohol content of about 15% to about 35% by weight of the soft baked snack, the sugar alcohol content including erythritol;
c. a fiber content of at least 20% by weight of the soft baked snack;
d. a sugar content of less than 15% by weight of the soft baked snack, wherein the sugar alcohol content, the fiber content, the sugar content, and a total carbohydrate content of the soft baked snack combine to achieve a net carbohydrate content of less than 25% by weight of the soft baked snack;
e. a calorie content of 100 calories or less per 25 g of the soft baked snack;
f. a moisture content of about 10% to about 18% by weight of the soft baked snack; and
g. a water activity of less than 0.70,
wherein the soft baked snack has a texture measured using instrumental texture profile analysis (TPA) as having a resilience, springiness, and cohesion that are significantly (>95% confidence) lower than cake, and a hardness that is significantly (>95% confidence) less than a crunchy cookie.

2. The soft baked snack of claim 1, wherein the soft baked snack has a texture measured using a descriptive analysis panel (DAP) as having a first bite denseness, a first chew hardness, a first chew denseness, and a first chew cohesiveness that are greater than cake, and a first chew hardness that is less than a crunchy cookie.

3. (canceled)

4. The soft baked snack of claim 2, wherein the resilience is less than 25%, the springiness is less than 80%, the cohesion is less than 0.6, and the hardness is less than 3000 g.

5. The soft baked snack of claim 1, wherein the protein content is from 3% to 10% by weight of the soft baked snack.

6. The soft baked snack of claim 1 , wherein the net carbohydrate content is from about 15% to less than 25% by weight of the soft baked snack.

7. The soft baked snack of claim 1 , wherein the sugar content is from about 5% to about 10% by weight of the soft baked snack.

8. The soft baked snack of claim 1 , wherein the sugar alcohol content further includes at least one additional sugar alcohol, with erythritol being 50% to 90% of the sugar alcohol content by weight.

9. The soft baked snack of claim 8, wherein the at least one additional sugar alcohol comprises glycerol or sorbitol.

10. The soft baked snack of claim 1 ,wherein the fiber comprises inulin or soluble corn fiber.

11. The soft baked snack of claim 1 , wherein the calorie content is 60 to 90 calories per 25 g of the soft baked snack.

12. The soft baked snack of claim 1 , further comprising a fat content of less than 20%.

13. The soft baked snack of claim 1 , wherein the moisture content is from about 11% to about 15% by weight of the soft baked snack.

14. The soft baked snack of claim 1 , wherein the water activity is from about 0.55 to about 0.65.
